(19) United States
(12) Patent Application Publication
(10) Pub. No.: US 2003/0110055 A1
(43) Pub. Date: Jun. 12, 2003

(54) Electronic catalogue

(76) Inventor: Bang Thinh Chau, Maroubra (AU)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/257,314

(22) PCT Filed: Apr. 10, 2001
(86) PCT No.: PCT/AU01/00399

(30) Foreign Application Priority Data
Apr. 10, 2000 (AU) PR0968

(51) Int. Cl. G06F 17/60

(52) U.S. Cl. 705/1

(57) ABSTRACT

A method of classifying items in an electronic catalogue, the method comprising the steps of associating a relation identifier with a pair of items, wherein the relation identifier specifies a categorisation relation between the items of the pair.

### FIELD OF THE INVENTION

The present invention relates broadly to data (content) management and integration, and particularly, but not exclusively, to an electronic catalogue and a method of classifying or categorising products in an electronic catalogue. The classification of products is sometimes referred to as a “taxonomy”. The present invention will be described herein with reference to an electronic catalogue for goods. However, it will be appreciated that the present invention is not limited to the exact nature of the electronic catalogue. Rather, it could include any form of electronic catalogue, e.g. used to incorporate services, electronic documents or the content of web sites on the Internet. Note that the term “item” in this specification is intended to encompass any type of data entity within such an electronic catalogue. Note also that the term “product” includes both goods and services.

### BACKGROUND OF THE INVENTION

Presently, electronic catalogues are typically maintained using a hierarchical categorisation structure 100 as illustrated in FIG. 1, i.e. a structure in which “fixed” multiple relation chains e.g. 110 between items are established.

Changes in the relation between two items e.g. 112, 114 of the chain 110 (or branch) of the categorisation structure 100 typically require the creation of a new fixed chain or chains of multiple relations which makes modifying an existing categorisation system 110 a cumbersome exercise.

Note that the term “items” in this specification includes categories (“category-items”). So, for example, in FIG. 1 category-item 116 may actually be a parent classification such as “vehicle”. Category-item 112 may refer to the type of vehicle such as for example, “car” and category-item 114 may refer to a make of car. In this example, therefore, the vehicle 116 is the parent of car 112 which is in turn the parent of make of vehicle 114. The various items are associated in a parent/child manner. At the bottom of the hierarchy will be a product-item (a product), such as product-item 118. In this example, this would be a particular vehicle which had been specified within the taxonomy.

Turning to FIG. 2a, transferring portions of one electronic catalogue 120 to another 122, both of which are structured in the way described above, is practically impossible unless an entire fixed multiple relation chain e.g. 124 of one of the catalogues 120 can be added by defining a single relation with one of the items of the other catalogue 122.

Furthermore, even when a single relation can be defined between the fixed multiple relation chain 124 of the one catalogue 120 with one item 126 of the other catalogue 122 (see FIG. 2b), it is for all practical purposes only when that one item 126 belongs to the lowest categorisation level 128 that the transfer can be performed without a major reconstruction of the existing catalogue 122. This is because of the likelihood of incompatibilities between the level structures of the electronic catalogues 120 and 122.

Further, in traditional business systems the ontology (data describing the physical properties or characteristics) of a product includes information about the product's taxonomy (data identifying how products are classified/categorised/grouped). That is, the data elements that define a product include the data elements that define category codes. So the classification (or organisation or grouping) of products is seen as a property or characteristic of that product.

For example, in defining the product “car” the properties describing a car include things like its make, model, price, colour, engine type (“attributes”) AND also how it is organised in the catalogue (categorisation). So a specific car is defined not only by its physical properties but also by which category/group it belongs to, such as, “motor vehicle” or “transport equipment” or “automobiles”:

“Holden [make], Commodore [model], $25,000 [price], Silver [colour], V6 3.0 litre [engine type] AND automobile [a sub-category of motor vehicle], motor vehicle [a sub category of machines], machines [a sub-category of etc. . .].”

This approach is restrictive from a product data management point of view because in reality, how or why a product is classified does not change the physical properties or characteristics of that product.

Further, in traditional systems, classification information is organised in a structure resembling a tree-like hierarchy, as discussed above. With more detail at the lower levels and converting into less details at the higher levels, there are usually many sub-categories to a parent category of the next higher category level. When this tree-like hierarchy is stored in a relational database for example, each level in the hierarchy is mapped to a column in the database table.

This imposes restrictions such that:

the maximum number of levels a classification structure can have is limited by the number of columns that the database table was originally created or designed for; and

a category has to be either a parent or a child of another category. It cannot be both at the same time

for any given business context, each classification structure usually requires a separate table with a different set of level-to-column mappings; and

changes to the classification structure must be reflected by changing the data elements in every product that relate to category codes; and

there cannot be direct and dynamic relationship between the different classification structures, that is, if the same category code exists in different trees, it is considered as different categories with a common name and maintained independently. A category code that belongs to more than one level in the tree hierarchy is considered as different categories with a common name and maintained independently. This is because a category has to be either a parent or a child of another category. It cannot be both at the same time.

These restrictions imply that database and software code has to be rewritten when the user requires more:

classification structures than the system was originally designed for

more levels in the classification hierarchy than the product tables allow for

For example:

a product cannot belong to more than one category in the same level in a particular tree hierarchy, that is, a car cannot be both “automobile” and “electric mobile” (assuming that both these categories are a sub-category of “motor vehicle”)

each category can only belong to one category at the level above it in the tree hierarchy.

### SUMMARY OF THE INVENTION

In accordance with a first aspect of the present invention there is provided a method of classifying items in an electronic catalogue, the method comprising the steps of associating a relation identifier with a pair of items, wherein the relation identifier specifies a categorisation relation between the items of the pair.

For example, one item of a pair may be “vehicle” and the other item of the pair may be “car”. In this case, “vehicle” is the parent of “car” and the relation identifier specifies that the vehicle is the parent of the car. An item (product-item) may also (as discussed above) be a particular product “good or service” e.g. a particular car. This is the item that would usually be at the bottom of the classification tree in a traditional structure.

The categorisation relation between the items of the pair may comprise one of the group of one of the items of the pair being a parent to the other item of the pair; one of the items of the pair being a child to the other item of the pair; the items of the pair being siblings; and the items being synonymous.

Accordingly, the method can provide a flexible categorisation as it defines one-on-one relations between the items of the electronic catalogue, rather than creating “fixed” multiple relations chains. This can enable the creation of an item network, which is a more realistic representation of the relations between items in an electronic catalogue.

It will be appreciated by a person skilled in the art that in at least preferred embodiments of the present invention, any categorisation structure can be defined through definition of one-on-one relations between the items. Furthermore, utilising one-on-one relation definition can enable combination/transfer of data between different electronic catalogues. This is because it involves simply the definition of new one-on-one relations whilst maintaining the categorisation relations of the items with other items of their original electronic catalogue which are combined/transferred together.

The method may further comprise the step of associating a context identifier (an alternative term for this is “perspective identifier”) with the pair of items, and associating the relation identifier with the pair of items and the context identifier.

The method preferably comprises associating different context identifiers with the same pair of items, and preferably associating different relation identifiers with each combination of the pair of items and the different context identifiers.

Accordingly, the method can be utilised to effect different categorisations of the items in different contexts, e.g. user specific categorisations (or perspectives).

These user specific categorisations can be used to determine what “perspective” a user “views”, e.g. users may be allowed access to different perspectives depending on level of security, type of enquiry, age, etc.

Preferably, the method comprises the step of creating a first database table for associating the relation identifier with the pair of items.

In one embodiment, the method further comprises the step of creating a second database table for defining the categorisation relation specified by the relation identifier.

Advantageously, the step of creating the first database table comprises arranging the first database table in a manner such that it associates the context identifier with the pair of items and the relation identifier with the pair of items and the context identifier.

Each item of a plurality of items of the electronic catalogue can form a pair with one or more of the other items of the electronic catalogue.

Advantageously, the method can further comprise the step of mapping relationships between items of the electronic catalogue and other items of a different electronic catalogue in accordance with the method defined in the first aspect of the present invention.

Together with the existing associations between relation identifiers and pairs of items of the individual catalogues, this can create a combined electronic catalogue.

Where a classification of the other items in the different electronic catalogue is not provided in accordance with the first aspect of the present invention defined above, the step of mapping the relationships comprises may comprise extracting individual one of the other items from data entries in the different electronic catalogue.

The step of mapping the relationships may preferably comprise providing rules for mapping the relationships. The step of providing the rules may preferably comprise the steps of monitoring a command entered manually by a user of the electronic catalogue during manual mapping of the relationships; requesting confirmation from the user that a particular command should be stored as a rule in a fourth database table of the electronic catalogue; and storing the command as the rule in a database.

The method can further comprise the step of applying at least one of the rules stored in the database to facilitate the mapping.

The new association between relation identifiers and pairs of one item of the electronic catalogue with one item of the second electronic catalogue may be stored in a third database table.

The present invention preferably allows catalogue data to be organised and managed with an unlimited number of taxonomies (classification structures) in a non-programmatic way. It also allows a customisation, in a non-programmatic way, of these taxonomies into context (otherwise known as “perspectives”, which can give user-personalised usage of the catalogue) according to individual user needs.

Preferably, therefore, no programming changes are required either to the database structure or to the application code level to create, change or delete taxonomies. This is in contrast to traditional systems that have programmatic or database constraints on the number of and type of classification structure. When their predefined limit is reached or when a new structure that was not originally designed for is required, the software will need programming modifications to accommodate the new taxonomies, in these traditional systems.

In accordance with a second aspect of the present invention there is provided an electronic catalogue comprising means for associating a relation identifier with a pair of items, wherein the relation identifier specifies a categorisation relation between the items of the pair.

The categorisation relation between the items of the pair may comprise one of the group of one of the items of the pair being a parent to the other item of the pair; one of the items of the pair being a child to the other item of the pair; and the items of the pair being siblings.

The electronic catalogue may further comprise means for associating a context identifier with the pair of items, and the means for associating the relation identifier is arranged, in use, to associate the relation identifier with the pair of items and the context identifier.

The means for associating the relation identifier preferably is arranged, in use, to associate different context identifiers with the same pair of items, and the means for associating the relation identifier is arranged, in use, to associate different relation identifiers with each combination of the pair of items and the different context identifiers.

Preferably, means for associating the relation identifier comprises a first database table for associating the relation identifier with the pair of items.

In one embodiment, the electronic catalogue further comprises a second database table for defining the categorisation relation specified by the relation identifier.

Advantageously, the first database table is arranged in a manner such that it associates the context identifier with the pair of items and the relation identifier with the pair of items and the context identifier.

Each item of a plurality of items of the electronic catalogue can form a pair with one or more of the other items of the electronic catalogue.

Advantageously, the means for associating the relation identifier is arranged to map relationships between items of the electronic catalogue and other items of a different electronic catalogue.

Together with the existing associations between relation identifiers and pairs of items of the individual catalogues, this can create a combined electronic catalogue.

Where the different electronic catalogue is not in accordance with the first aspect of the present invention defined above, the electronic catalogue can further comprise means for extracting individual ones of the other items from data entries in the different electronic catalogue.

The electronic catalogue may be arranged, in use, to provide rules for mapping the relationships. The electronic catalogue may comprise means for monitoring a command entered manually by a user of the electronic catalogue during manual mapping of the relationships; means for requesting confirmation from the user that a particular command should be stored as a rule in a fourth database table of the electronic catalogue; and means for storing the command as the rule in a database.

The electronic catalogue may further be arranged, in use, to apply at least one of the rules stored in the database to facilitate the mapping.

The electronic catalogue can be arranged to store new associations between relation identifiers and pairs of one item of the electronic catalogue and one item of the second electronic catalogue in a third database table.

In accordance with a third aspect of the present invention there is provided a computer program element comprising computer program code means to instruct a computer for classifying items in an electronic catalogue to associate a relation identifier with a pair of items, wherein the relation identifier specifies a categorisation relation between the items of the pair.

In accordance with a fourth aspect of the present invention there is provided a computer readable medium having a program recorded thereon, wherein the program is arranged to instruct a computer for classifying items in an electronic catalogue to associate a relation identifier with a pair of items, wherein the relation identifier specifies a categorisation relation between the items of the pair.

As discussed above, in traditional systems the ontology (data describing the physical properties or characteristics) of a product includes information about the products taxonomy (data identifying how products are classified/categorised/grouped). Preferably, in the present invention taxonomy (classification) and ontology (data describing properties or “attributes”) are treated separately.

In accordance with a third aspect of the present invention, there is provided a method of classifying items in an electronic catalogue, the method comprising the steps of separating treatment of taxonomy of the items from ontology of the items.

Preferably, the method includes the step of providing a first database arrangement which deals with taxonomy, and a separate database arrangement which deals with ontology. The databases are preferably linked so that an item's ontology can be accessed via the taxonomy database, and, preferably, vice versa.

Preferably, the ontology databases and taxonomy databases can be treated and organised totally separately, which provides flexibility. The present applicants have developed a novel method for organising ontology for electronic catalogues, which is described in the copending International (PCT) Patent Application entitled “Electronic Catalogue” filed on the same day as this application, and the disclosure of which is incorporated herein by reference.

Preferably, in this third aspect of the present invention, the arrangement that deals with taxonomy is as discussed above in relation to the first and second aspects of the present invention, and this is preferably linked to an arrangement dealing with ontology as described in the above-referenced copending PCT application.

In accordance with a fourth aspect of the present invention, there is provided a tool for constructing a system for implementing the method of the first aspect of the present invention.

Preferably the tool includes software instructions for instructing a computing system to implement the system.

In accordance with a fifth aspect of the present invention, there is provided a tool for constructing an electronic catalogue in accordance with the second aspect of the present invention.

Preferably, the tool includes software instructions for instructing a computing system to construct the electronic catalogue.

Preferred forms of the invention will now be described, by way of example only, with reference to the accompanying drawings, in which:

### BRIEF DESCRIPTION OF THE DRAWINGS

FIG. 1 is a schematic diagram illustrating a prior art electronic catalogue.

FIGS. 2A and 2B are schematic diagrams illustrating features of prior art electronic catalogues.

FIG. 3 is a schematic diagram illustrating a representation of a database table in accordance with an embodiment of an electronic catalogue of the present invention;

FIG. 3A is a schematic illustration of a further database table of an electronic catalogue in accordance with an embodiment of the present invention;

FIG. 4 is a schematic diagram illustrating database tables of electronic catalogues in accordance with embodiments of the present invention;

FIG. 5 is a schematic diagram illustrating linking of electronic catalogues in accordance with embodiments of the present invention;

FIG. 6 is a schematic diagram illustrating database tables utilised in a method of treating ontology in an electronic catalogue;

FIG. 7 is a schematic illustration of database tables in the method for linking the ontologies of the method of FIG. 6, and

FIG. 8 is a schematic illustration of database tables illustrating linkage of a taxonomy database in accordance with the present invention with the ontology databases of FIGS. 6 and 7.

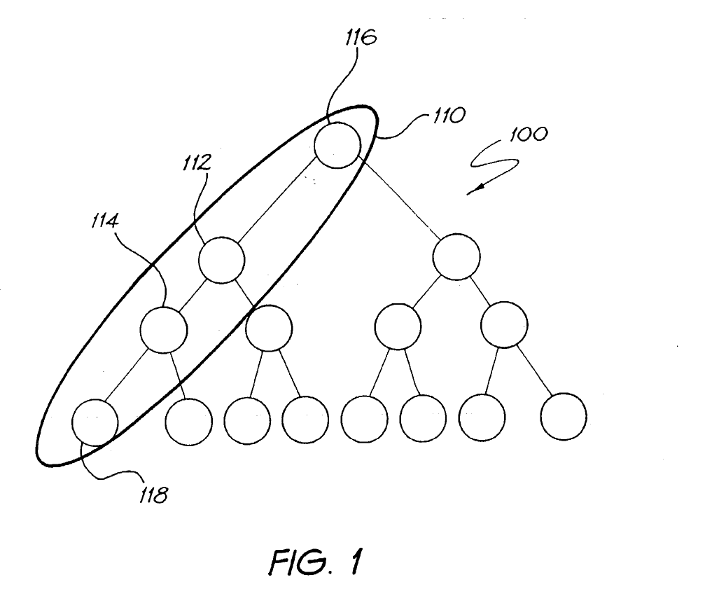

### DETAILED DESCRIPTION OF THE PREFERRED EMBODIMENT

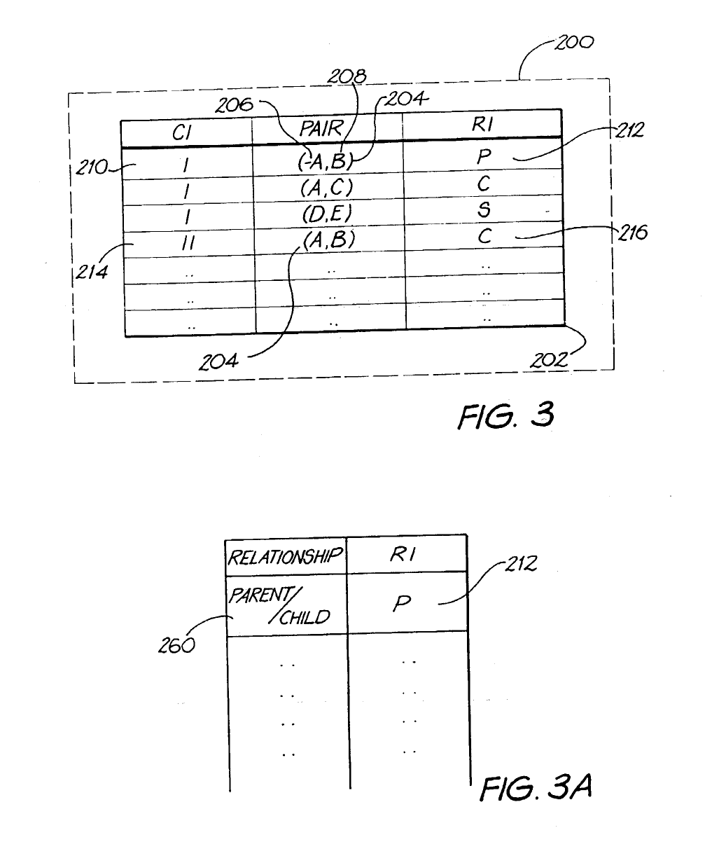

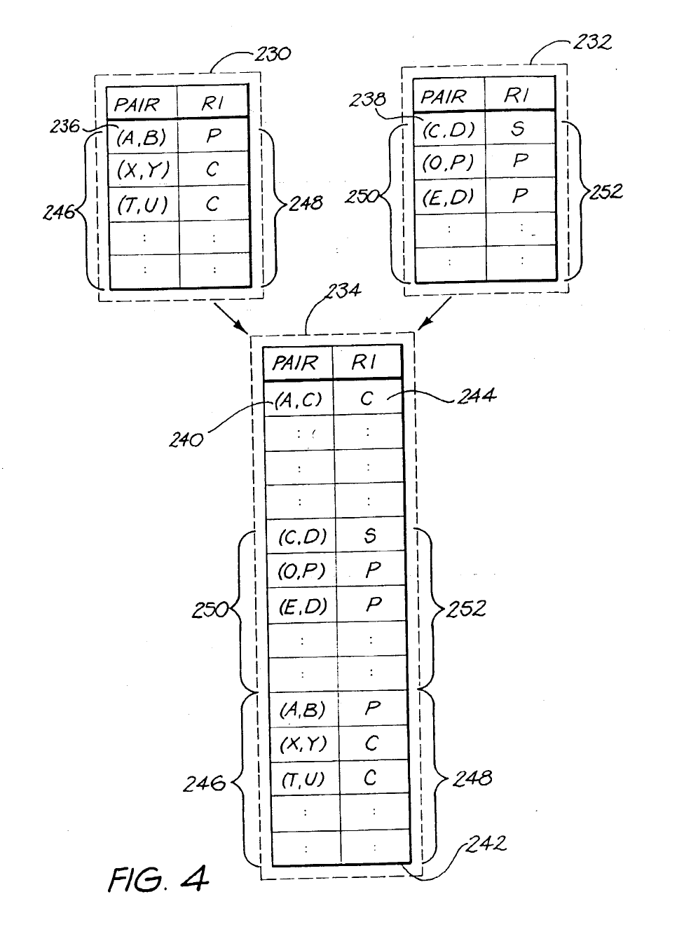

In FIG. 3, an electronic catalogue 200 embodying the present invention includes a first database table 202. In the first database table 202, pairs e.g. 204 of items e.g. 206, 208 are associated with a context identifier e.g. 210. Furthermore, a relation identifier e.g. 212 is associated with the combination of the context identifier 210 and the pair of items 204.

It is noted that the same pair 204 of items is associated also with a different context identifier 214. For this combination, a different relation identifier 216 is associated therewith within the database table 202. It will be appreciated by a person skilled in the art that this enables e.g. customising the electronic catalogue 200 to different users or for different tasks or priorities.

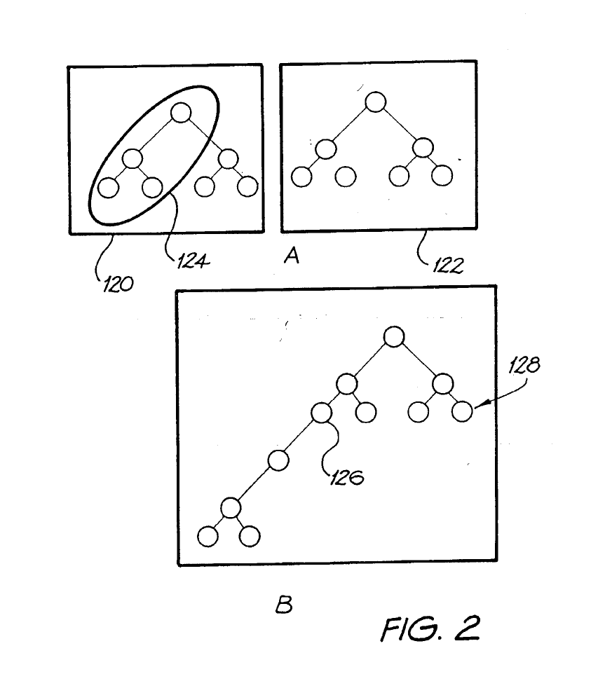

It will further be appreciated by a person skilled in the art that a database table such as the first database table 202 of the above described electronic catalogue 200 can be utilised to define any particular categorisation structure of items, e.g. a tree structure as illustrated in FIG. 2. However, any other categorisation structure can also be defined in a database table such as the first database table 202 of the electronic catalogue 200 described above. This is because it has been recognised that in order to improve the flexibility of categorisation structures, the structures should be defined using the “smallest” building blocks, i.e. the definition of one-on-one categorisation relations between the items.

In the above example, the item pairs may include pairs of category-items e.g. A may be the category “vehicle” and B may be the category “car” (e.g. car being a type of vehicle). The relationship identifier P may be a “parent” (meaning that the vehicle is in this relationship the parent of the “car”). The item pairs may also include a category-item and a product item e.g. the category “car” may be a parent (P) of a particular car which is one of the item pairs.

FIG. 3A shows a representation of a database table for defining the categorisation relation specified by the relation identifier. For example, for relation identifier 212, the categorisation relation stated is parent/child 260.

Turning now to FIG. 4, it will be described below how two electronic catalogues 230, 232 can be combined into a new electronic catalogue 234.

For combining the data in the first electronic catalogue 230 with the data in the second electronic catalogue 232, what is required is to simply identify individual items e.g. 236 of the first electronic database table 230 that have a relation with individual ones of the items e.g. 238 of the second electronic catalogue 232. The respective individual items, e.g. 236 and 238 do then form a new pair 240 of a database table 242 of the new electronic catalogue 234. A relation identifier 244 is then associated with the pair 240, which effectively has formed a tie between data of the first electronic catalogue 230 and data of the second electronic catalogue 232.

Importantly, all of the associations between pairs of items 246 and respective ones of the relation identifiers 248 are simply copied into the database table 242 of the new electronic database table 234. The same applies to the associations between the pairs 250 and respective ones of the relation identifiers 252 of the second database table 232.

It will be appreciated by a person skilled in the art that in combining the electronic catalogue 230 with the electronic catalogue 232 no problem caused by incompatibilities between hierarchy levels of fixed multiple relation chains (as discussed in the introduction with reference to FIG. 2) applies for the preferred embodiment described above.

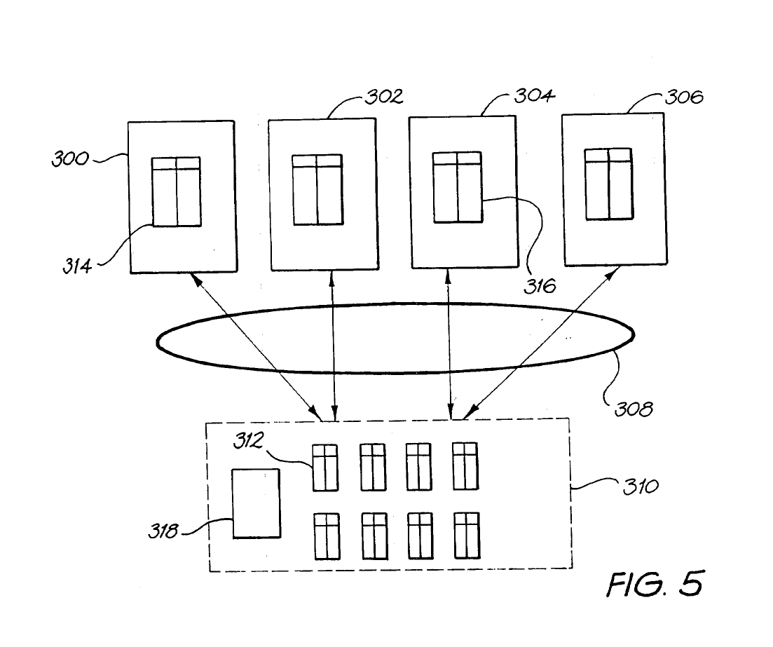

Turning now to FIG. 5, in a different embodiment of the present invention, a plurality of electronic catalogues 300, 302, 304 and 306 may each be accessible through a computer network 308. A central user interface system 310 is provided, which comprises a plurality of database tables e.g. 312. Those individual database tables, e.g. 312 contain associations of pairs of individual items from two different ones of the plurality of electronic catalogues 300, 302, 304 and 306 and respective relation identifiers.

If a user wishes to access a combined database table consisting of e.g. electronic catalogue 300 and 304, the interface system 310 is arranged to select the suitable ones of its database tables e.g. 312. Together with the associations downloaded or interactively accessed from the respective database tables 314, 316 of the electronic catalogues 300 and 304, the interface system 310 can thus provide a “virtual” combined catalogue consisting of electronic catalogue 300 and electronic catalogue 304.

All user interface tools such as search engines provided on the user interface system 310 can therefore conveniently be applied to the virtual combined electronic catalogue. Rules utilised in the creation of the “virtual” combined catalogue are stored in a database 318 of the user interface system 310. The user interface system 310 in this embodiment is arranged to monitor commands entered by a user during manual creation of the “virtual” combined catalogue, to request confirmation whether a command should be stored as a rule in the database 318, and to store the rule for later automatic re-application in the database 318 upon confirmation.

With the present invention, there is no limit on:

the number of classification structures that can be defined

the number of levels in each classification structure

how the user can change these structures without having to change the data elements/values for every product item in the hierarchy.

In the present invention classification information is stored and managed as a “network” of classification structures and the relationship between them. These classification structures may or may not be tree-like. This network model for classification structures allows each category to have as many parent and/or children (sub) categories as needed. It gives the user the flexibility to organise, manage and present the classification structures in both a single tree hierarchy, or a multitude of inter-connected (inter-related) tree hierarchies.

For example:

a car can be a “motor vehicle” and “automobile” and “machines” and “small” simultaneously even though some of these categories exist in the same level in the same tree hierarchy.

Additionally, this allows the catalogue user to present sections of the network classification structures (or partial view of the whole structure) in any number of individual tree-like classification structures depending on user needs. This capability allows the catalogue taxonomies to be customised easily into “perspectives” (or views, using the context identifiers) that are peculiar to an individual/group of users. Hence, one flexible classification structures is maintained (behind the scenes) but can be used or seen as a multitude of separate or inter-connected tree-like classification structures.

For example:

The same “automobile” category can be a sub-category of “motor vehicle” in one part of the network classification structure but in another part, “automobile” category can be a parent category of “motor vehicle”. This then allows different sections of same classification structure to be presented in different tree-like “perspectives” with the same categories having different parent/child relationships depending on the perspective. Therefore, maintenance of the classification structure is simplified enormously. Additionally, each node in the network can have characteristics or rules information that allows it to determine the nature of the relationship that it can have with any other node.

For example:

category “A” (Item A) can simultaneously be a parent, child or “same as” any other category in the network classification structure but the user sees only one of these relationship in any given “perspective”

a category can have “acceptance rules” that control which product or category that it can have a relationship with and the type of relationship it has

a product can have “placement rules” that determine which category or product it can have a relationship with and the type of relationship it has.

A perspective (identified by the context identifiers) is one particular taxonomy (set of relationships between category-items) that the product-items belong to. The table of FIG. 3 relates the context identifier CI with the relationship identifier RI between two items (whether product-item or category-item).

For example:

In a perspective called “Books”, the categories “Fiction” and “Non-Fiction” can be related (linked) with ‘children categories’ of the top (or root) category in the taxonomy of “Books”. A category called “Sci-Fi” in perspective “Books” may be a ‘child category’ of “Fiction” and then the book item “Star Wars” (actual book title) can have a relationship ‘belongs to’ with category “Fiction”. In another perspective, called “Literature by Author”, the categories “Fiction” and “Non-Fiction” may not be relevant, but now you have “Contemporary”, “Classical” and “Scientific” as ‘child’ categories of the top (or root) category called “Compiled Materials—Books”. Here, the book item “Star Wars” (actual book title) can have a relationship ‘belongs to’ with category “Contemporary” because “Sci-Fi” is no longer relevant. “Star Wars” can even have a relationship ‘belongs to ’ with “Compiled Materials—Books” simultaneously.

In fact, a product-item can have as many relationships with category-items as the user desires. Similarly, a category-item can have as many relationships with other category-items as desired, such that, “Sci-Fi” can simultaneously be a child category to many parent categories as desired (e.g. child of “Non-Fiction”, “Contemporary”, “Children's Books”, “20^{th} Century Fantasy” etc). All that is required is for a new ‘link’ (relationship identifier) to be created in the table of FIG. 3—this is a simple Cut/Paste operation, no programming needed.

The above example illustrates how a ‘perspective’, which is in essence a taxonomy in ‘one’ particular context can then be related to another ‘perspective’ (or taxonomy in another perspective). Hence, FIGS. 4 & 5 illustrate how, even though there may be many different users with different ‘perspectives’ (or views of their own catalogue), the “Links∞ table (FIG. 3) can pull all different types of items together, across many perspectives to form an ‘aggregated virtual catalogue’. The user can inter-relate different sections of a taxonomy to form new perspectives simply by forming new ‘links’ (relationship IDs).

‘Perceived’ taxonomy trees can be ‘linked’ (related) to create what is in essence a complex ‘network’ of items.

A method and system for handling ontology of items will now be described (this system is also described in the copending PCT application referenced above) This method and system may be utilised together with the taxonomy method in the system of the present invention to fully define properties of items in an electronic catalogue.

This ontology method preferably comprises a method of defining the properties of items in an electronic catalogue comprising the steps of:

associating at least one of a plurality of property set identifiers with each item, wherein each property set identifier is in turn associated with a set of properties;

defining each item utilising the set of properties associated with the property set identifier associated with each item.

This ontology system preferably comprises an electronic catalogue comprising:

means for associating at least one of a plurality of property set identifiers with each of a plurality of items of the electronic catalogue;

means for associating each property set identifier with a set of properties; and

means for defining each item utilising the set of properties associated with the property set identifier associated with each item.

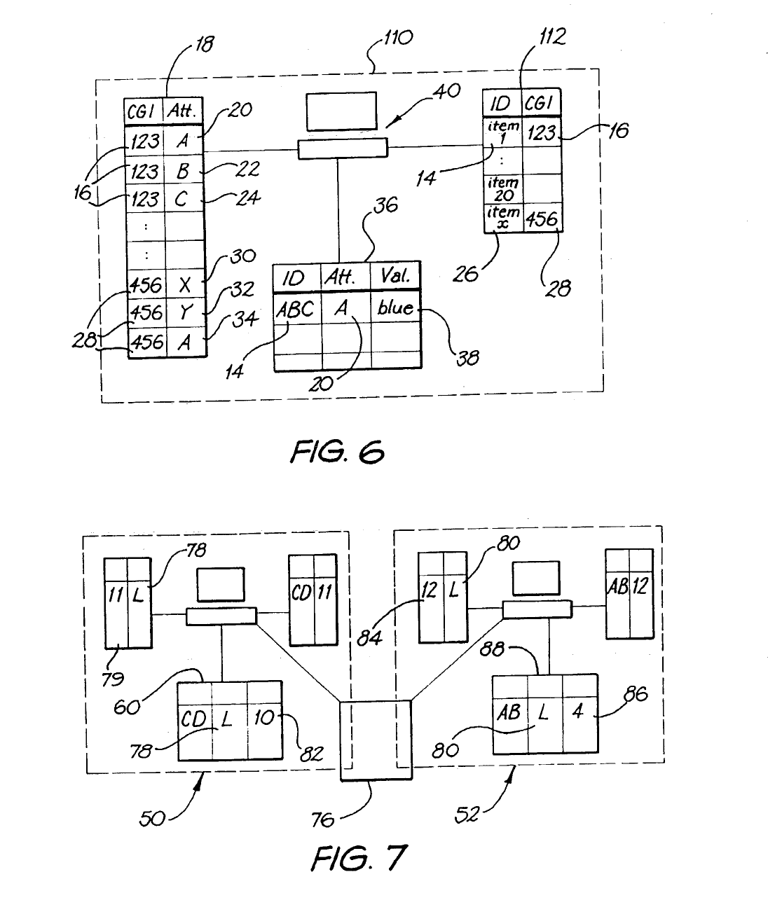

In FIG. 6, an electronic catalogue 11 for handling ontology comprises a first database table 12 in which particular product-items e.g. 14 are associated with respective property set identifiers, e.g. 16.

A “property set” in this description is descriptive of an “ontology” of an item. An ontology is a set of properties (attributes) used to define an item or group of items. Each property set identifier is in turn associated with a set of properties (attribute-items) and the item can be defined utilising the set of properties.

The electronic catalogue 10 also comprises a second database table 18 in which a set of properties (attribute-items), e.g. 20, 22 and 24 are associated with property set identifiers, e.g. 16.

For example, a particular product-item may be associated with a property set of attribute-items, e.g. a car may be associated with attribute-items such as “colour”, “engine size”, etc. Table 11 provides an association between a property set identifier and a product-item (such as a car), and table 18 then relates that property set identifier to a number of attribute-items (e.g. “colour”, “engine size”).

It will be appreciated by a person skilled in the art that by way of provision of the first database table 12 and the second database table 18, a multitude of property sets having different sets of properties (attribute-items) associated with them can be incorporated into the electronic catalogue 11, without having to change the hard-coding (i.e. the column headings) of the database tables 12 and 18.

If a new product-item 26 is to be added to the electronic catalogue, for which none of the previous property set is suitable, a new property set identifier 28 is added in the database table 112. At the same time, a new set of properties (attribute-items) 30, 32 and 34 are associated with the new property set identifier 28 in the second database table 18.

It is noted here that the same property can belong to different sets of properties associated with respective ones of the property set identifiers, see e.g. property 20, 34.

The electronic catalogue 11 further comprises a third database table 36 in which the actual values, e.g. 38 of attributes e.g. 20 of a particular item e.g. 14 are stored.

Editing of data in the electronic catalogue 11 is facilitated through a user interface in the form of a desktop computer 40. It will be appreciated by a person skilled in the art that the addition of product-items and/or attribute-item sets (property sets) in the above described embodiment does not require any hard coding to effect changes in the various database tables 12, 18 and 36. Rather, the addition of data simply requires entering of data into the existing, hard coded database tables 112, 18 and 36. Accordingly, this is a task which does not require specific programming skills. This makes the editing of the electronic catalogue 11 easy and cost effective.

With the present invention, therefore, different ontology “templates” can easily be created for new item classes without programmatic changes.

In the example of FIG. 6, item classes will be associated with the same ontology (property set). For example items 1 through 20 may all be cars. The associated property set identifier 123 may include a property set which includes colour (A), engine size (B) car type (e.g. saloon, sports car, etc, data element C). Any item class “car” associated with property set identifier 123 will have the same ontology. This ontology can be added to by adjusting table 18 to add in another data element in addition to data elements 20(A), 22(B) and 24(C). This is a simple matter of adding the data element and associating it with the same property set identifier 123. The appropriate value for the data element is inserted in table 36, against the appropriate item.

All items of the same class can be accessed via the property set identifier, that is specific to describing their properties. The ontology can be extended by manipulating table 18.

Items of different classes can be included in the table 112. Any items may be included, e.g. cars, books, clothes, etc, all in the same table. Different data classes can be associated with different ontologies (property sets). The number of ontologies that can be supported is basically unlimited.

Different ontologies can be defined for the same item classes, the ontologies being user defined to customise data elements that are visible to particular users i.e. what “ontology perspective” a particular user has. For example, what information a user is able to view may depend on a particular security level i.e. the higher security level, the more information that a particular user is able to view. Particular users, therefore, may only be able to utilise particular ontologies for particular item classes. Each user may have a different “ontology perspective”. This can easily be handled by defining different ontologies for different item classes associated with different user perspectives.

In more detail, without requiring programming changes (hard coding, changing of columns of the database) there is no limit on:

The number of data elements (or attributes) that can be defined

The number of ontologies that can be defined

How the user can use these ontologies to customise the data elements that are visible for every product item and to every user (in “ontology perspectives”).

Following from the Above Example:

The User Simply Adds New Data Elements When Required:

ISBN, Author, Title, RRPrice, Number of Pages, Year Published; Publisher; Language; Edition; UOM; Catalogue Number; Artist, Album Title, Number of Tracks; Year Released; Record Company; Language; Volume; Label; Designer; Article Name; Style; Cut; Colour; Season; Material 1; Material 2; Care Instructions; Ironing Instruction; Size Chest; Size Collar; Brand, Type, Article Name, Colour; Ingredients 1; Ingredients 2 etc; Serving Instruction, Pack Size; Gross Weight; Net Weight; Use By Date

These data elements can then be “assembled” into a template called an “ontology” for each product class, for instance:

BOOKS ontology has data elements: ISBN, Author, Title, RRPrice, Number of Pages, Year Published; Publisher; Language; Edition; UOM

CDs ontology has data elements: Catalogue Number; Artist, Album Title, Number of Tracks; Year Released; Record Company; Language; Volume; UOM

SHIRTS ontology has data elements: Label; Designer; Article Name; Wholesale Price; First Cost; Packaging Cost; Freight Cost; RRPrice; Promotion Price; Style; Cut; Colour; Season; Material 1; Material 2; Care Instructions; Ironing Instruction; Size Chest; Size Collar; UOM

CANDY ontology has data elements: Brand; Type; Article Name, RRPrice; Colour; Ingredients 1; Ingredients 2 etc; Serving Instruction, Pack Size; Gross Weight; Net Weight; UOM, Use By Date

Additionally, when new product classes are required, new data elements can be added and new ontology templates can be created using any data element from the list of user-defined elements.

Another application of this is to create different ontologies to control the amount of product information that different users can see in their ‘perspective’ of the catalogue.

For example:

For shirts, the catalogue manager can create different SHIRTS ontologies for different users such as, customers, suppliers, accounting staff, sales staff etc.

SHIRTS ontology has data elements: Label; Designer: Article Name; Wholesale Price; First Cost; Packaging Cost; Freight Cost; RRPrice; Promotion Price; Style; Cut; Colour; Season; Material 1; Material 2; Care Instructions; Ironing Instruction; Size Chest; Size Collar; UOM

SHIRTS ontology for Customer 1 has data elements: Label; Designer; Article Name; RRPrice; Style; Cut; Colour; Season; Material 1; Material 2; Care Instructions; Ironing Instruction; Size Chest; Size Collar; UOM

SHIRTS ontology for Customer 2 has data elements: Label; Designer; Promotion Price; Style; Cut; Colour; Season; Material 1; Care Instructions; Ironing Instruction; Size Chest; Size Collar; UOM

SHIRTS ontology for Accounting Staff has data elements: Label; Designer; Article Name; Wholesale Price; First Cost; Packaging Cost; Freight Cost; RRPrice; Style; Cut; Colour; Season; Size Chest; Size Collar; UOM

SHIRTS ontology for Sales staff has data elements: Label; Designer; Article Name; RRPrice; Promotion Price; Style; Cut; Colour; Season; Material 1; Material 2; Care Instructions; Ironing Instruction; Size Chest; Size Collar; UOM.

It will be appreciated that the use of this method and system for organising ontology is not limited to product-items. Category-items also may have their own ontology e.g. a book may have the ontology including attribute-items “fiction”, “non-fiction” etc. Table 11 can also therefore include category-items and associated property set identifiers for the category-item ontology. In this sense there is some cross over between taxonomy and ontology in the present invention.

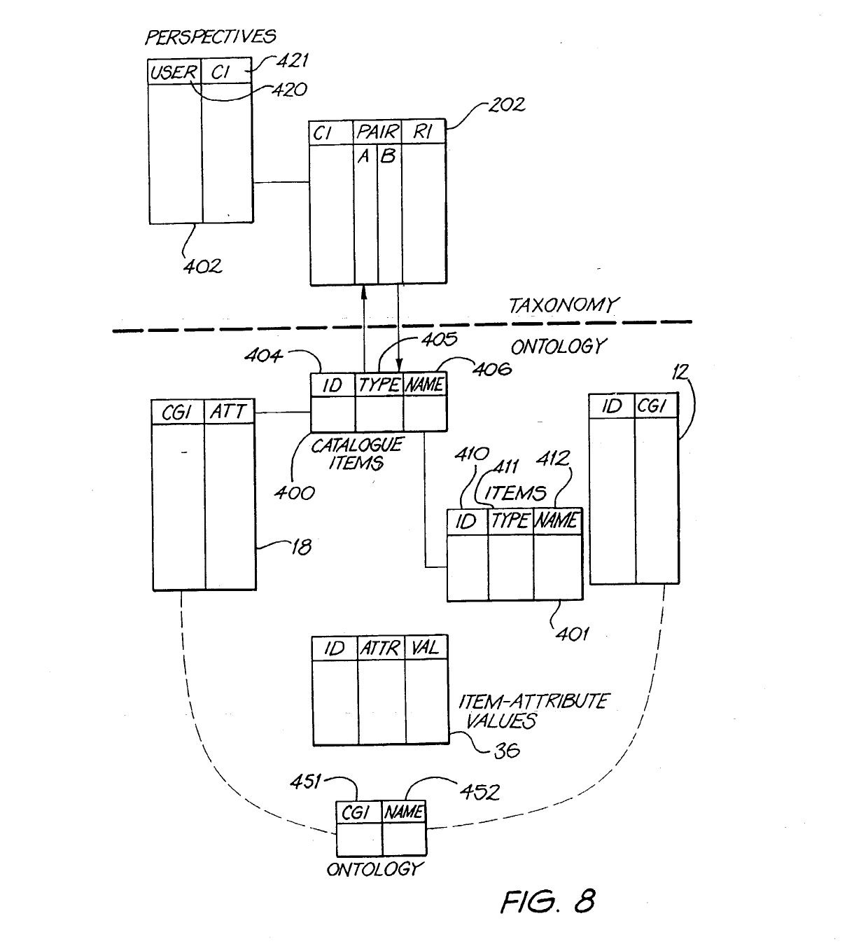

Turning now to FIG. 7, there are shown two separate electronic catalogues 50, 52. Each of the catalogues 50, 52 is substantially structured in the same way as the electronic catalogue 11 of FIG. 2 described above.

In the following, different scenarios for transferring items (product-items or category-items) or groups of items between the electronic catalogues 50, 52 will be described.

Firstly, if an identical property set exists in catalogue 52 to the one to which the item to be transferred from catalogue 50 belongs, the transfer is a matter of copying the relevant data from the database table 60 of catalogue 50, in which the actual values of properties are stored for the particular items (compare database table 36 of FIG. 2).

Alternatively, should an identical property set exist in catalogue 52 but a different property set identifier is being used, the transfer will require execution of a rule: All items of the catalogue 50 having property set identifier 246 should be transferred into catalogue 52 with the property set identifier being changed to 789, which is the property set identifier in catalogue 52 which is associated with an identical set of properties as used for those items in catalogue 50.

This rule, which is initially manually entered by a user of the catalogue 52 is subsequently stored in a rule database 76. The rule database 76 is accessible by both catalogues 52 and 50. Any future transfer can utilise prior rules established by different users. The rule database 76 is arranged to notify a future user upon entering of a particular transfer request if a rule is already stored in the rule database 76 for a corresponding previous request. The rule database 76 is further arranged to apply the stored rule automatically in executing the new transfer request.

The rule database 76 further comprises means for generating “reverse” rules for transfer in an opposing direction between the catalogues 52, 50 on the basis of a transfer rule created manually for transfer in one particular direction.

It will be appreciated by a person skilled in the art that the principle of rule-based transfer of data described above also applies to a scenario where it is desired to transfer data between the catalogues 50, 52 where certain values need to be changed due to differences in the properties associated with a particular property set identifier.

This will also involve the mapping of relations between properties of the catalogues 50, 52.

For example, if a length property 78 of a classification group 79 in catalogue 50 is in centimetres whilst the length property 80 of a corresponding property set in catalogue 52 is in inches, a transfer rule would have to be applied in which the value 82 is converted into inches during transfer into a value 86 in database table 88 of catalogue 52. It will be appreciated that conversion of certain values of properties would in that case be favourable rather than creating an entirely new property set in catalogue 52, which would be the easier transfer. This is because it would be advantageous to keep items which should belong into the same property set by their nature together in the same property set.

Different examples of where applying rules to conform the transferred data is preferable over simply adding the data “as received” from another database table include where properties are identified by different names but their meaning is the same. This may be due e.g. simply because of different spelling in different languages, such as colour versus colour.

A system for handling taxonomy of the present invention and the ontology system described above can be linked together so that one can refer to the other so that, for example, a particular product-item can be searched for via the taxonomy and then when located, the ontology can be accessed. Separation of taxonomy and ontology into two different systems means that they can be organised separately, providing much more flexibility.

Referring to FIG. 8, there is illustrated a schematic representation of how taxonomy in accordance with the present invention is linked to the ontology system described above. Database tables corresponding to the database tables of the previous figures are given the same reference numerals. In addition to these tables, there are some further tables including a catalogue-item table 400, a product-item table 401 and a perspectives table 402.

The catalogue-item table 400 includes a list of identifications of the catalogue-items and product-items which exist as pairs in table 202. The id 404 is any id that can be used internal to the system. The type 405 identifies whether the id'd item is a catalogue-item or a product-item (both of which, as will be realised from the above description of the taxonomy aspect of the invention can be included in the table 202). The “name” 406 column includes a name which can be viewed by user e.g. “book”, “fiction”, “vehicle” etc. The items table 401 includes product-items only and a more specific description of their “type”. ID column 410 includes an internal identification of the particular product-item. The type column 411 includes a more specific description of what the item is, for the benefit of the user. The “name” column includes a name 412 which can be viewed by the user for the item.

The perspectives table 402 defines user access to context identifiers (perspectives) via a user column 420 and a context identifier column 421, which links with the table 202.

In operation, therefore, for example, if a user wishes to view a catalogue from a particular perspective he selects the context identifier (or if he is restricted to using a particular context identifier uses that context identifier) to view the catalogue. Via the relationship identifier the system can link pairs of items to provide a taxonomy which the user can view from the particular perspective that they are viewing from. The user can step through the categories and select an item which may have an ontology. The system then links to the ontology system via the catalogue-item table and the user can view the ontology of the selected item. The table 202 is utilised by the system to provide a “view” of a taxonomy depending on the context identifier used. Taxonomies that can be created from the table 202 are unlimited.

In FIG. 8 a further table, an ontology table 450 is included which relates the property set identifier (column 451) with a name column 452 which can be accessed by a user for easy user identification of the item and its relationship to the ontology.

With the present invention a tool, preferably a software tool, is provided to enable a person to construct the electronic catalogue described above on a computing system. This, as will be appreciated by the skilled person, can be developed from the above description of the electronic catalogue.

In the above description and in the following claims the term “electronic catalogue” should be taken to mean any catalogue or database which can be implemented by a computing system, and, as computing systems develop into the future this is not necessarily limited to electronic computing systems.

In the above description, databases have been represented as tables, having columns and rows. It will be appreciated that this is a representation only that can be easily understood by humans, and in a computing system the data may be stored in any format, not necessarily in a table structure.

The term “electronic catalogue” has been used throughout this description. The present invention has general application, not just to electronic catalogues, but general application for the management of data and integration. Other applications are managing directories of people and company's details (such as names and addresses in the phone directory). A further application could be the integration and sharing of data between business systems (such as ERP, CRM and other legacy systems). A fourth application could be the management of electronic documents (for example, medical records or web pages). The term electronic catalogue should be considered to be used very broadly in this context therefore, to cover any data management and integration application.

It will be appreciated by a person skilled in the art the electronic catalogue of the present invention may be implemented on any computing system, whether a desktop or a network computing system, or any other type of computing system.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication, the word “comprising” is used in the sense of “including”, i.e. the features specified may be associated with further features in various embodiments of the invention.

The claims defining the invention are as follows:

1. A method of classifying items in an electronic catalogue, the method comprising the steps of:
associating a relation identifier with a pair of items, wherein the relation identifier specifies a categorisation relation between the items of the pair.

2. A method as claimed in claim 1, wherein the categorisation relation between the items of the pair comprises one of the group of one of the items of the pair being a parent to the other item of the pair; one of the items of the pair being a child to the other item of the pair; and the items of the pair being siblings.

3. A method as claimed in claims 1 or 2, wherein the method further comprises the steps of associating a context identifier with the pair of items, and associating the relation identifier with the pair of items and the context identifier.

4. A method as claimed in claim 3, wherein the method comprises associating different context identifiers with the same pair of items, and associating different relation identifiers with each combination of the pair of items and the different context identifiers.

5. A method as claimed in any one of the preceding claims, wherein the method comprises the step of creating a first database table for associating the relation identifier with the pair of items.

6. A method as claimed in any one of the preceding claims, wherein the method further comprises the step of creating a second database table for defining the categorisation relation specified by the relation identifier.

7. A method as claimed in claim 5, wherein the step of creating the first database table comprises arranging the first database table in a manner such that it associates the context identifier with the pair of items and the relation identifier with the pair of items and the context identifier.

8. A method as claimed in any one of the preceding claims, wherein each item of a plurality of items of the electronic catalogue can form a pair with one or more of the other items of the electronic catalogue.

9. A method as claimed in any one of the preceding claims, wherein the method further comprises the step of mapping relationships between items of the electronic catalogue and a other items of a different electronic catalogue in accordance with the method steps defined in claim 1.

10. A method as claimed in claim 9, wherein, if a classification of the other items in the different electronic catalogue is not provided in accordance with method as claimed in claim1, the step of mapping the relationships comprises extracting individual one of the other items from data entries in the different electronic catalogue.

11. A method as claimed in claims 9, 10, wherein the step of mapping the relationships comprises providing rules for mapping the relationships.

12. A method as claimed in claim 11, wherein the step of providing the rules comprises the steps of monitoring a command entered manually by a user of the electronic catalogue during manual mapping of the relationships; requesting confirmation from the user that a particular command should be stored as a rule in a fourth database table of the electronic catalogue; and storing the command as the rule in a database.

13. A method as claimed in claim 12, wherein the method comprises the step of applying at least one of the rules stored in the database to facilitate the mapping.

14. A method as claimed in any one of claims 9 to 13, wherein the new association between relation identifiers and pairs of one item of the electronic catalogue with one item of the second electronic catalogue is stored in a third database table.

15. An electronic catalogue comprising:
means for associating a relation identifier with a pair of items, wherein the relation identifier specifies a categorisation relation between the items of the pair.

16. An electronic catalogue as claimed in claim 15, wherein the categorisation relation between the items of the pair comprises one of the group of one of the items of the pair being a parent to the other item of the pair; one of the items of the pair being a child to the other item of the pair; and the items of the pair being siblings.

17. An electronic catalogue as claimed in claims 15 or 16, wherein the electronic catalogue further comprises means for associating a context identifier with the pair of items, and wherein the means for associating the relation identifier is arranged, in use, to associate the relation identifier with the pair of items and the context identifier.

18. An electronic catalogue as claimed in claim 17, wherein the means for associating the context identifier is arranged, in use, to associate different context identifiers with the same pair of items, and the means for associating the relation identifier is arranged to associate different relation identifiers with each combination of the pair of items and the different context identifiers.

19. An electronic catalogue as claimed in any one of claims 15 to 18, wherein the means for associating the relation identifier comprises a first database table for associating the relation identifier with the pair of items.

20. An electronic catalogue as claimed in any one of claims 15 to 19, wherein the electronic catalogue further comprises a second database table for defining the categorisation relation specified by the relation identifier.

21. An electronic catalogue as claimed in claim 19, wherein the first database table is arranged in a manner such that, in use, it associates the context identifier with the pair of items and the relation identifier with the pair of items and the context identifier.

22. An electronic catalogue as claimed in any one of claims 15 to 21, wherein each item of a plurality of items of the electronic catalogue can form a pair with one or more of the other items of the electronic catalogue.

23. An electronic catalogue as claimed in any one of claims 15 to 22, wherein the means for associating the relation identifier is arranged, in use, to map relationships between items of the electronic catalogue and other items of a different electronic catalogue.

24. An electronic catalogue as claimed in claim 23, wherein, if the different electronic catalogue is not in accordance with claim 1, the electronic catalogue can further comprise means for extracting individual ones of the other items from data entries in the different electronic catalogue.

25. An electronic catalogue as claimed in claims 23 or 24, wherein the electronic catalogue is arranged, in use, to provide rules for mapping the relationships.

26. An electronic catalogue as claimed in claim 25, wherein the electronic catalogue comprises means for monitoring a command entered manually by a user of the electronic catalogue during manual mapping of the relationships; means for requesting confirmation from the user that a particular command should be stored as a rule in a fourth database table of the electronic catalogue; and means for storing the command as the rule in a database.

27. An electronic catalogue as claimed in claim 26, wherein the electronic catalogue is further arranged, in use, to apply at least one of the rules stored in the database table to facilitate the mapping.

28. An electronic catalogue as claimed in any one of claims 23 to 27, wherein the electronic catalogue is arranged, in use, to store new associations between relation identifiers and pairs of one item of the electronic catalogue and one item of the second electronic catalogue in a third database table.

29. A computer program element comprising computer program code means to instruct a computer for classifying items in an electronic catalogue to associate a relation identifier with a pair of items, wherein the relation identifier specifies a categorisation relation between the items of the pair.

30. A computer readable medium having a program recorded thereon, wherein the program is arranged to instruct a computer for classifying items in an electronic catalogue to associate a relation identifier with a pair of items, wherein the relation identifier specifies a categorisation relation between the items of the pair.

31. A method of classifying items in an electronic catalogue, the method comprising the steps of separating treatment of taxonomy of the items from ontology of the items.

32. A method in accordance with claim 31 including the step of providing a first database arrangement which deals with taxonomy, and a separate database arrangement which deals with ontology.

33. A method in accordance with claim 32, wherein the databases are linked so that an item's ontology can be accessed via the taxonomy database.

34. A tool for constructing a system for implementing the method of any one of claims1 to 14.

35. A tool for constructing an electronic catalogue in accordance with any one of claims 15 to 28.
